(19) United States
(12) Patent Application Publication
(10) Pub. No.: US 2021/0182103 A1
(43) Pub. Date: Jun. 17, 2021

(54) METHOD AND APPARATUS FOR PROCESSING TO SUPPORT SCALABILITY IN MANY-CORE ENVIRONMENT

(71) Applicant: Electronics and Telecommunications Research Institute, Daejeon (KR)

(72) Inventors: Seung Hyub JEON, Anyang-si Gyeonggi-do (KR); Jin Mee KIM, Sejong-si (KR); Sung-In JUNG, Daejeon (KR); Yeon Jeong JEONG, Daejeon (KR); Seung-Jun CHA, Daejeon (KR)

(73) Assignee: Electronics and Telecommunications Research Institute, Daejeon (KR)

(21) Appl. No.: 17/103,551

(22) Filed: Nov. 24, 2020

(30) Foreign Application Priority Data
Dec. 11, 2019 (KR) 10-2019-0164631
Nov. 12, 2020 (KR) 10-2020-0151230

(51) Int. Cl. G06F 9/50; G06F 9/52

(52) U.S. Cl. CPC G06F 9/50; G06F 9/52

(57) ABSTRACT

A method and an apparatus for processing to support scalability in a many-core environment are provided. The processing apparatus includes: a counter unit configured to include a global reference counter, at least one category reference counter configured to access the global reference counter, and at least one local reference counter configured to access the category reference counter; and a processor connected to the counter unit and configured to increase or decrease each reference counter. The at least one category reference counter has a hierarchical structure including at least one layer.

### CROSS-REFERENCE TO RELATED APPLICATION

This application claims priority to and the benefit of Korean Patent Application Nos. 10-2019-0164631 filed in the Korean Intellectual Property Office on Dec. 11, 2019 and 10-2020-0151230 filed in the Korean Intellectual Property Office on Nov. 12, 2020, the entire contents of which are incorporated herein by reference.

### BACKGROUND OF THE INVENTION

### (a) Field of the Invention

The present disclosure relates to a data processing method, and more particularly, to a method and an apparatus for processing to support scalability in is a many-core environment.

### (b) Description of the Related Art

In a multi-thread environment using a multicore, a synchronization scheme such as spinlock is generally used to write or read a value in one piece of shared data, thereby maintaining the consistency of shared data. This is effective when the number of cores is small, but as the number of cores increases, it causes cache bouncing and the like, resulting in a scalability problem that greatly degrades performance of a system or a program.

In particular, in places such as the kernel, a large number of reference counters are maintained to maintain various information of the system, and these reference counters are configured to be protected by a synchronization scheme such as spinlock. Therefore, when many cores or threads read or write the reference counter at the same time, there is a structural problem that reduces the scalability of the kernel.

In order to solve this problem, a sloppy counter that separates counters into a local counter and a global counter and performs reading and writing has been introduced. When a single thread executes writing, the sloppy counter first writes to a local counter that only it can access. Then, when the range of the logical count exceeds a certain threshold, it is reflected in the global count protected by the synchronization scheme as in the past, and thereby minimizing contention between cores or threads, reducing cache bouncing problems, and providing scalability.

However, if the environment gets more and more cores, contention for global counters occurs and scalability is limited.

The above information disclosed in this Background section is only for enhancement of understanding of the background of the disclosure, and therefore it may contain information that does not form the prior art that is already known in this country to a person of ordinary skill in the art.

### SUMMARY OF THE INVENTION

The present disclosure has been made in an effort to provide a method and an apparatus for processing to effectively support scalability in a many-core environment,

An exemplary embodiment of the present disclosure provides a processing apparatus for supporting scalability in a many-core environment. The processing apparatus includes: a counter unit configured to include a global reference counter, at least one category reference counter configured to access the global reference counter, and at least one local reference counter configured to access the category reference counter; and a processor connected to the counter unit and configured to increase or decrease each reference counter, wherein the at least one category reference counter has a hierarchical structure including at least one layer.

In an implementation, the processor may be configured to perform an operation in units of threads, increase a local reference counter at each operation, and increase a category reference counter when a value of the local reference counter is greater than or equal to a first threshold.

In an implementation, a local reference counter may be formed for each thread, and one category gaunter may be configured to support a preset number is of threads.

In an implementation, one category counter may be configured to support local reference counters respectively corresponding to threads having similar characteristics.

In an implementation, the layer may include a preset number of category reference counters, and when a number of category reference counters included in the layer exceeds the preset number, a new layer may be additionally formed, and category reference counters exceeding the preset number may be configured to be included in the new layer,

In an implementation, the at least one category reference counter may have a hierarchical structure including a plurality of layers, and each layer may include a preset number of category reference counters, a category reference counter included in a highest layer of the plurality of layers may be configured to access the global reference counter, and a local reference counter may be configured to access a category reference counter included in a lowest layer of the plurality of layers.

In an implementation, in a system to which the processing apparatus is applied, a category reference counter may be configured on a per-socket basis of a memory.

In an implementation, the processor may be further configured to perform an increment on a category reference counter, and then, when a value of the category reference counter is greater than or equal to a second threshold, perform an increment on a category reference counter of an upper layer of the category reference counter or the global reference counter.

In an implementation, after performing an increment on a category reference counter, or after performing an increment on a category reference counter of an upper layer of the category reference counter or the global reference counter, the processor may be further configured to initialize the local reference counter having the value greater than or equal to the first threshold or the category reference having the value greater than or equal to the second threshold.

Another embodiment of the present disclosure provides a processing method for supporting scalability in a many-core environment, The processing method includes: performing an increment on a corresponding local reference counter for each thread; and accessing, by the processing apparatus, a category reference counter corresponding to a local reference counter, instead of a global reference counter, and performing an increment on the category reference counter when a value of the local reference counter is greater than or equal to a first threshold, wherein the category reference counter is configured to access the global reference counter and has a hierarchical structure.

In an implementation, the accessing of a category reference counter may include: comparing a first threshold with a value of a local reference counter corresponding to a thread on which an operation is performed; performing an increment on a category reference counter corresponding to the local reference counter when the value of the local reference counter is greater than or equal to the first threshold; and initializing the value of the local reference counter.

In an implementation, after the accessing of a category reference counter, the processing method may further include: comparing a value of the category reference counter with a second threshold; determining whether there is a category reference counter of an upper layer corresponding to the category reference counter when the value of the category reference counter is greater than or equal to the second threshold; performing an increment on the category reference counter of the upper layer when there is the category reference counter of the upper layer corresponding to the category reference counter; and initializing the value of the category reference counter.

In an implementation, the processing method may further include: performing an increment on the global reference counter when there is no category reference counter of the upper layer corresponding to the category reference counter; and initializing the value of the category reference counter.

In an implementation, the category reference counter may have a hierarchical structure including at least one layer and the layer may include a preset number of category reference counters, wherein when a number of category reference counters included in the layer exceeds the preset number, a new layer may be additionally formed, and category reference counters exceeding the preset number may be configured to be included in the new layer.

In an implementation, a local reference counter may be formed for each thread, one category counter may be configured to support a preset number of threads, and may further support local reference counters respectively corresponding to threads having similar characteristics.

In an implementation, the category reference counter may have a hierarchical structure including a plurality of layers, and each layer includes a preset number of category reference counters, a category reference counter included in a highest layer of the plurality of layers may be configured to access the global reference counter, and the local reference counter may be configured to access a category reference counter included in a lowest layer of the plurality of layers.

### BRIEF DESCRIPTION OF THE DRAWINGS

FIG, 1 is a diagram showing the concept of a sloppy counter.

FIG. 2 is a diagram showing the structure of a processing apparatus in a many-core environment according to an embodiment of the present disclosure.

FIG. 3 is a diagram showing an exemplary implementation of a processing apparatus according to an embodiment of the present disclosure.

FIG. 4 is a flowchart of a processing method for supporting scalability according to an embodiment of the present disclosure,

FIG. 5 is a structural diagram illustrating a computing device for implementing a processing method according to an embodiment of the present disclosure,

### DETAILED DESCRIPTION OF THE EMBODIMENTS

In the following detailed description, only certain exemplary embodiments of the present disclosure have been shown and described, simply by way of illustration. Hereinafter, embodiments of the present disclosure will be described in detail with reference to the accompanying drawings so that those of ordinary skill in the art may easily implement the present disclosure. As those skilled in the art would realize, the described embodiments may be is modified in various different ways, all without departing from the spirit or scope of the present disclosure. Accordingly, the drawings and description are to be regarded as illustrative in nature and not restrictive. Like reference numerals designate like elements throughout the specification.

Throughout the specification, in addition, unless explicitly described to the contrary, the word “comprise”, and variations such as “comprises” or “comprising”, will be understood to imply the inclusion of stated elements but not the exclusion of any other elements.

The expressions described in the singular may be interpreted as singular or plural unless an explicit expression such as “one”, “single”, and the like is used.

In addition, terms including ordinal numbers such as “first” and “second” used in embodiments of the present disclosure may be used to describe components, but the components should not be limited by the terms. The terms are only used to distinguish one component from another. For example, without departing from the scope of the present disclosure, a first component may be referred to as a second component, and similarly, the second component may be referred to as the first component.

Hereinafter, a method and an apparatus for processing to support scalability in a many-core environment according to an exemplary embodiment of the present disclosure will be described.

FIG. 1 is a diagram showing the concept of a sloppy counter.

The sloppy counter has the same number of threads and the number of cores, and each core has one local counter because each core executes one is thread. That is, there is a local reference counter 1 that can only be accessed by each thread or core, and each thread or core writes only to its own local reference counter 1.

The reference counter 1 has one lock. When the value counted by the local reference counter 1 exceeds a preset threshold, a global reference counter 2 is accessed. At this time, in order to access the global reference counter 2, the thread or core acquires write permission in the synchronization scheme that protects the global reference counter 2, and when it acquires the write permission, the value counted in the local reference counter 1 is reflected in the global reference counter 2. Thereafter, the counter value of the local reference counter 1 reflected in the global reference counter 2 is initialized to 0.

As a specific example, in FIG. 1, it is assumed that each thread performs an operation that increases by one. Assuming that the threshold value of each local reference counter 1 is 10 and the global reference counter 2 is protected by spinlock, each thread increases the value of its own local reference counter every nine operations. In the case of the 10th operation, since the counted value has reached the threshold value, after acquiring the lock of the spin lock of the global reference counter 2, each thread increases the value of the global reference counter 2 by 10, unlocks the lock, and then initializes the value of the local reference counter 1 to 0. This prevents all threads from competing in the global reference counter 2 every time.

However, in such a sloppy counter, it is possible to prevent each thread operation from directly causing contention to the global reference counter, but contention when local reference counters simultaneously access the global is reference counter cannot be prevented. In the above example, when the counted values of all local reference counters simultaneously exceed the threshold value, all local reference counters compete for access to the global reference counter. This contention has no effect when the number of cores is small, but in a many-core environment where the number of cores is more than 100, it causes the same cache bouncing problem that occurred when the sloppy counter was not used.

In an embodiment of the present disclosure, instead of the local reference counter directly accessing the global reference counter, the global reference counter is accessed using a hierarchically configurable category reference counter

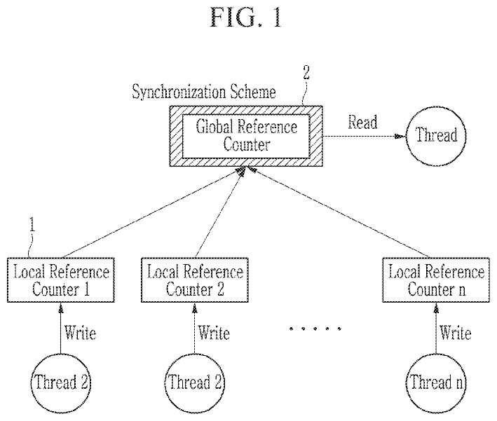

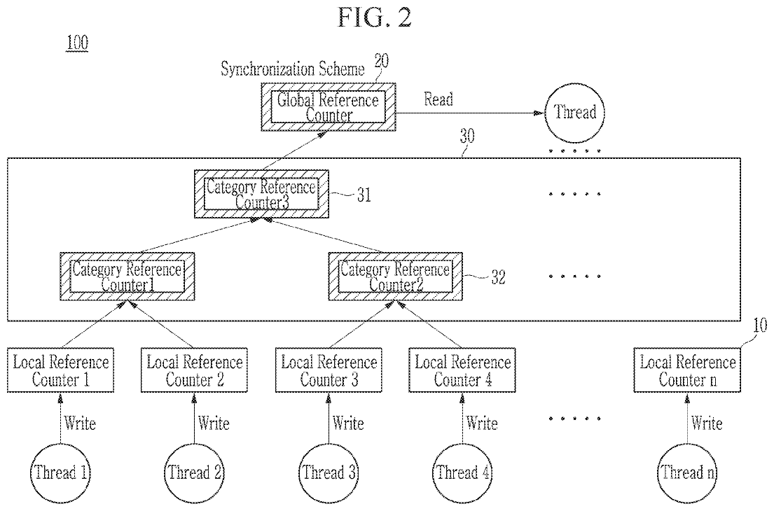

FIG. 2 is a diagram showing the structure of a processing apparatus in a many-core environment according to an embodiment of the present disclosure.

As shown in FIG. 2, the processing apparatus 100 supporting scalability of the counter variable in a many-core environment according to an embodiment of the present disclosure includes a local reference counter 10, a global reference counter 20, and a category reference counter 30. In particular, the category reference counter 30 has a hierarchical structure.

The category reference counter 30 may have a hierarchical structure including at least one layer. The number of category reference counters included in one layer may be a preset number, and when the number of category reference counters included in a layer is greater than or equal to the preset number, the category reference counters can be divided into a plurality of layers and configured hierarchically. For example, when the number of category reference counters configured in one layer is greater than or equal to the preset number, the category reference counters of the corresponding layer may be divided into category reference counters of layer 1 and category reference counters of layer 2 to form a hierarchical structure.

The category reference counter 30 may be configured to support only a preset number, for example, up to a maximum of 32 threads. When contention in the global reference counter 20 is caused because the number of category reference counters is greater than or equal to the preset number, the category reference counters are hierarchically configured so that the category reference counters of more than the preset number do not access the global reference counter 20. Thus, scalability can be provided. The hierarchy of the category reference counter may be statically fixed, and the hierarchy of the category reference counter may be dynamically reconfigured according to system conditions.

As a specific example, the category reference counter 30 may be composed of two layers, as shown in FIG. 2. In other words, it consists of a category reference counter 31 of an upper layer and a category reference counter 32 of a lower layer, and the category reference counter 32 of the lower layer may be configured to access the category reference counter 31 of the upper layer. The number of category reference counters included in each layer is within the preset number.

The category reference counter 30 is configured to perform access to the global reference counter 20. When the category reference counter 30 has a hierarchical structure, the category reference counter of the upper layer is (specifically, the highest layer n the case of three or more layers) is configured to be able to access the global reference counter 20, and the category reference counter of the lower layer is configured to be able to access the category reference counter of the upper layer above it.

The local reference counter 10 is configured so that only each thread or core can access it, and there are local reference counters (local reference counter 1, local reference counter 2, . . . , local reference counter n) corresponding to each thread or core. The local reference counter 10 is further configured to be able to access the category reference counter 30. When the category reference counter 30 has a hierarchical structure, the local reference counter 10 is configured to be able to access the category reference counter of the lowest layer (the category reference counter 32 of the lower layer in FIG. 2).

Meanwhile, the category reference counter 30 may be bound according to threads having similar characteristics based on the characteristics of hardware or software. For example, when a thread 1 and a thread 2 are similar, one category reference counter, that is, category reference counter 1, is configured to support a local reference counter 1 corresponding to the thread 1 and a local reference counter 2 corresponding to the thread 2. Further, when a thread 3 and a thread 4 are similar, the category reference counter 2 is configured to support a local reference counter 3 corresponding to the thread 3 and a local reference counter 4 corresponding to the thread 4.

A plurality of threads share these counters existing in memory, and each thread performs increment or decrement on the counter. Here, increment indicates increasing the value of the counter, for example, increasing the value by+1, and decrement indicates decreasing the value of the counter, for example, decreasing the value by−1. A thread represents a program execution unit such as a process. A thread is executed by a processor, that is, a core, and a core can execute a plurality of threads.

In an embodiment of the present disclosure, each thread proceeds to write only to its own local reference counter 10, and each local reference counter 10 does not directly access the global reference counter 20, but performs an operation to the category reference counter 30 and accesses the category reference counter of the upper layer or the global reference counter 20 according to the hierarchical structure of the category reference counter 30.

In the processing apparatus having this structure, for convenience of description, the local reference counter 10, the global reference counter 20, and the category reference counter 30 may be collectively referred to as a counter unit.

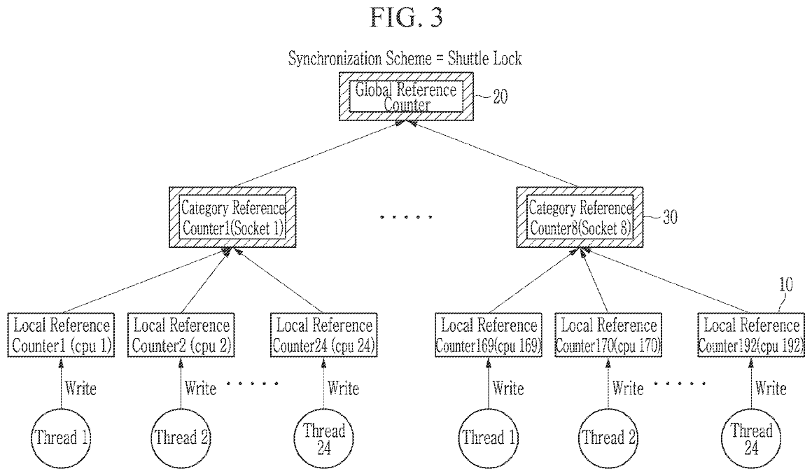

FIG. 3 is a diagram showing an example of implementation of a processing apparatus according to an embodiment of the present disclosure.

Here, an example in which a reference counter having a hierarchical structure is applied in a Non-Uniformed Memory Access (NUMA) system consisting of 24 cores and 8 sockets, which can have the largest number of cores currently in ×86, is described.

In the NUMA system, the maximum number of cores is 24×8=192, so when it is configured with the existing sloppy counter, scalability problems may occur depending on the access pattern. In an embodiment of the present disclosure, a category reference counter having a hierarchical structure is applied, and the category reference counter is configured on a per-socket basis.

The reason the category reference counter is configured on a per-socket basis is that the speed of accessing memory in the same socket in the NUMA system is faster than that of accessing memory in another socket.

As the category reference counter is configured on a per-socket basis, as shown in FIG. 3, up to 8 category reference counters are used. That is, the category reference counter 1 is configured for the socket 1 and the category reference counter 2 is configured for the socket 2, so that the category reference counter 1 to the category reference counter 8 are configured for the sockets 1 to 8.

In this case, since the number of category reference counters is 8, which is less than the preset number of 32, the category reference counter of the upper layer is not formed, but a category reference counter consisting of one layer and configured on a per-socket basis is used. Each category reference counter included in one layer is configured to be able to access the global reference counter 20.

For each category reference counter included in one layer, a local reference counter 1 to a local reference counter 24 corresponding to each core are configured. That is, 24 local reference counters 10 are configured to be able to access each category counter.

Meanwhile, a shuffle lock is used to protect the category reference counter 30 and the global reference counter 20, and it is determined whether contention is severe or not by maintaining the number of threads accessing the current reference counter or the number of waiters of the category reference is counter. If contention is severe, the intermediate tree is reconstructed using the shuffle lock policy.

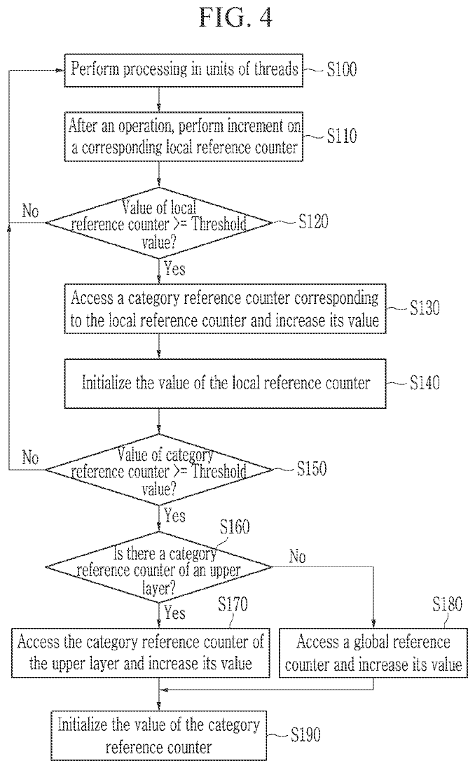

FIG. 4 is a flowchart of a processing method for supporting scalability according to an embodiment of the present disclosure.

In a many-core environment in which a plurality of cores (or a plurality of central processing units (CPU)) of a processing apparatus use data stored in a memory, data processing is performed in units of a plurality of threads, and each core performs an operation and performs an increment on the corresponding local reference counter (S100, S110).

The value of the local reference counter (a current counter value) and the threshold value are compared (S120), and if the value of the local reference counter is greater than or equal to the threshold value, the category reference counter corresponding to the local reference counter is accessed and its value of is increased (S130). At this time, when synchronization is secured by performing a synchronization acquisition process, the value of the category reference counter is increased, and in particular, it is increased to the current counter value of the local reference counter.

Thereafter, the value of the corresponding local reference counter is initialized (S140).

On the other hand, by comparing the value of the category reference counter and the threshold value (S150), if the value of the category reference counter is greater than or equal to the threshold value, it is determined whether there is a category reference counter of an upper layer corresponding to the category reference counter (S160). If there is a category reference counter of is the upper layer, the category reference counter of the upper layer is accessed and its value is increased (S170). On the other hand, if there is no category reference counter of the upper layer, the global reference counter is accessed and its value is increased (S180), Even when the steps S170 and S180 are performed, the synchronization acquisition process is performed, and when synchronization is secured, the value of the reference counter is increased, and in particular, it is increased to the current counter value of the corresponding category reference counter. Here, the threshold value used in step S120 and the threshold value used in step S150 may be different or the same. Then, the value of the corresponding category reference counter is initialized (S190).

This process is repeatedly performed for processing performed on a per-thread basis, and by hierarchically configuring category reference counters, it prevents category reference counters of more than the preset number from accessing the global reference counter. Thus, scalability may be provided.

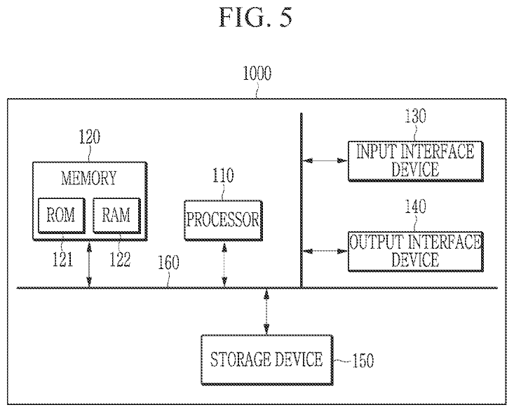

FIG. 5 is a structural diagram illustrating a computing device for implementing a processing method according to an embodiment of the present disclosure.

As shown in the accompanying FIG. 5, a processing method according to an embodiment of the present disclosure may be implemented using the computing device 1000.

The computing device 1000 may include at least one of a processor 110, a memory 120, an input interface device 130, an output interface device 140, and a storage device 150. Each of the components may be connected by a bus 160 to communicate with each other. In addition, each of the components is may be connected through an individual interface or an individual bus centered on the processor 110 instead of the common bus 160.

The processor 110 may be implemented in various types, such as an application processor (AP), a central processing unit (CPU), a graphical processing unit (GPU), etc., and may be any semiconductor device that executes commands stored in the memory 120 or the storage device 150. The processor 110 may execute a program command stored in at least one of the memory 120 and the storage device 150, This processor 110 may be configured to embody the functions and methods described based on FIGS. 1 to 4 above.

The memory 120 and the storage device 150 may include various types of volatile or nonvolatile storage media. For example, the memory may include read-only memory (ROM) 121 and random access memory (RAM) 122. In an embodiment of the present disclosure, the memory 120 may be located inside or outside the processor 110, and the memory 120 may be connected to the processor 110 through various known means. The memory 120 may be implemented to include reference counters, and the reference counters may include a local reference counter, a category reference counter, and a global reference counter having the structures shown in FIGS. 2 and 3.

The input interface device 130 is configured to provide data to the processor 110, and the output interface device 140 is configured to output data from the processor 110.

The computing device 1000 may also include a network interface device (not shown) that is electrically connected to a network, such as a wireless is network. The network interface device may transmit or receive signals with other entities through the network.

The computing device 1000 having such a structure is referred to as a processing device, and may implement a processing method according to an embodiment of the present disclosure.

In addition, at least some of the processing methods according to an embodiment of the present disclosure may be implemented as a program or software executed in the computing device 1000, and the program or software may be stored in a computer-readable medium.

In addition, at least some of the processing methods according to an embodiment of the present disclosure may be implemented with hardware that can be electrically connected to the computing device 1000.

According to embodiments, in a many-core environment where the number of cores increases, scalability may be provided through a hierarchical counter configuration.

In addition, it is possible to provide scalability for the sloppy counter that is widely used in reference variables that are already used in the many-core environment. In particular, by configuring the category reference counter hierarchically, it is possible to provide scalability to the kernel or user library in the many-core environment.

Furthermore, the efficiency of the system can be guaranteed by dynamically reconfiguring the counter hierarchy according to the system situation.

The embodiments of the present disclosure are not implemented only through the apparatus and/or method described above, but may be implemented through a program for realizing a function corresponding to the configuration of the embodiment of the present disclosure, and a recording medium in which the program is recorded. Also, this implementation can be easily performed by an expert in the technical field to which the present disclosure belongs from the description of the above-described embodiment.

The components described in the exemplary embodiments may be implemented by hardware components including, for example, at least one digital signal processor (DSP), a processor, a controller, an application-specific integrated circuit (ASIC), a programmable logic element such as an FPGA, other electronic devices, or combinations thereof. At least some of the functions or the processes described in the exemplary embodiments may be implemented by software, and the software may be recorded on a recording medium. The components, the functions, and the processes described in the exemplary embodiments may be implemented by a combination of hardware and software.

The method according to exemplary embodiments may be embodied as a program that is executable by a computer, and may be implemented as various recording media such as a magnetic storage medium, an optical reading medium, and a digital storage medium. Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages, and may be deployed in any form including a stand-alone program or a module, a component, a subroutine, or other units appropriate for use in a computing environment. A computer program may be deployed to be executed on one computer or on multiple computers at one site or distributed across multiple sites and interconnected by a communication network. Processors appropriate for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic disks, magneto-optical disks, or optical disks. Examples of information carriers appropriate for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc., and magneto-optical media such as a floptical disk, and a read only memory (ROM), a random access memory (RAM), a flash memory, an erasable programmable ROM (EPROM), and an electrically erasable programmable ROM (EEPROM), is and any other known computer readable medium. A processor and a memory may be supplemented by, or integrated into, a special purpose logic circuit. The processor may run an operating system (OS) and one or more software applications that run on the OS. The processor device also may access, store, manipulate, process, and create data in response to execution of the software. For the purpose of simplicity, the description of a processor device is used as singular; however, one skilled in the art will appreciate that a processor device may include multiple processing elements and/or multiple types of processing elements. For example, a processor device may include multiple processors or a processor and a controller, In addition, different processing configurations are possible, such as parallel processors. Also, non-transitory computer-readable media may be any available media that may be accessed by a computer, and may include both computer storage media and transmission media. The present specification includes details of a number of specific implements, but it should be understood that the details do not limit any disclosure or what is claimable in the specification but rather describe features of the specific exemplary embodiment. Features described in the specification in the context of individual exemplary embodiments may be implemented as a combination in a single exemplary embodiment. In contrast, various features described in the specification in the context of a single exemplary embodiment may be implemented in multiple exemplary embodiments individually or in an appropriate sub-combination. Furthermore, the features may operate in a specific combination and may be initially described as claimed in the combination, but one or more features may be excluded from the claimed is combination in some cases, and the claimed combination may be changed into a sub-combination or a modification of a sub-combination. Similarly, even though operations are described in a specific order in the drawings, it should not be understood as the operations needing to be performed in the specific order or in sequence to obtain desired results or as all the operations needing to be performed, In a specific case, multitasking and parallel processing may be advantageous. In addition, it should not be understood as requiring a separation of various apparatus components in the above-described exemplary embodiments in all exemplary embodiments, and it should be understood that the above-described program components and apparatuses may be incorporated into a single software product or may be packaged in multiple software products. It should be understood that the exemplary embodiments disclosed herein are merely illustrative and are not intended to limit the scope of the disclosure. It will be apparent to one of ordinary skill in the art that various modifications of the exemplary embodiments may be made without departing from the spirit and scope of the claims and theft equivalents.

What is claimed is:

1. A processing apparatus for supporting scalability in a many-core environment, comprising:
a counter unit configured to include a global reference counter, at least one category reference counter configured to access the global reference counter, and at least one local reference counter configured to access the category reference counter: and
a processor connected to the counter unit and configured to increase or decrease each reference counter,
wherein the at least one category reference counter has a hierarchical structure including at least one layer.

2. The processing apparatus of claim 1, wherein
the processor is configured to perform an operation in units of threads, increase a local reference counter at each operation, and increase a category reference counter when a value of the local reference counter is greater than or equal to a first threshold.

3. The processing apparatus of claim 1, wherein
a local reference counter is formed for each thread, and
one category counter is configured to support a preset number of threads.

4. The processing apparatus of claim 3, wherein
one category counter is configured to support local reference counters respectively corresponding to threads having similar characteristics.

5. The processing apparatus of claim 1, wherein
the layer includes a preset number of category reference counters, and
when a number of category reference counters included in the layer exceeds the preset number, a new layer is additionally formed and category reference counters exceeding the preset number are configured to be included in the new layer.

6. The processing apparatus of claim 1, wherein
the at least one category reference counter has a hierarchical structure including a plurality of layers, and each layer includes a preset number of category reference counters,
a category reference counter included in a highest layer of the plurality of layers is configured to access the global reference counter, and
a local reference counter is configured to access a category reference counter included in a lowest layer of the plurality of layers.

7. The processing apparatus of claim 1, wherein
in a system to which the processing apparatus is applied, a category reference counter is configured on a per-socket basis of a memory.

8. The processing apparatus of claim 2, wherein
the processor is further configured to perform an increment on a category reference counter, and then, when a value of the category reference counter is greater than or equal to a second threshold, perform an increment on a category reference counter of an upper layer of the category reference counter or the global reference counter.

9. The processing apparatus of claim 8, wherein
after performing an increment on a category reference counter or, after performing an increment on a category reference counter of an upper layer of the category reference counter or the global reference counter, the processor is further configured to initialize the local reference counter having the value greater than or equal to the first threshold or the category reference having the value greater than or equal to the second threshold.

10. A processing method for supporting scalability in a many-core environment, comprising:
performing, by a processing apparatus, an operation in units of threads and performing an increment on a corresponding local reference counter for each thread; and
accessing, by the processing apparatus, a category reference counter corresponding to a local reference counter, instead of a global reference counter, and performing an increment on the category reference counter when a value of the local reference counter is greater than or equal to a first threshold,
wherein the category reference counter is configured to access the global reference counter and has a hierarchical structure.

11. The processing method of claim 10, wherein
the accessing of a category reference counter comprises:
comparing a first threshold with a value of a local reference counter corresponding to a thread on which an operation is performed;
performing an increment on a category reference counter corresponding to the local reference counter when the value of the local reference counter is greater than or equal to the first threshold; and
initializing the value of the local reference counter.

12. The processing method of claim 10, further comprising,
after the accessing of a category reference counter:
comparing a value of the category reference counter with a second threshold;
determining whether there is a category reference counter of an upper layer corresponding to the category reference counter when the value of the category reference counter is greater than or equal to the second threshold;
performing an increment on the category reference counter of the upper layer when there is the category reference counter of the upper layer corresponding to the category reference counter; and
initializing the value of the category reference counter.

13. The processing method of claim 10, further comprising:
performing an increment on the global reference counter when there is no the category reference counter of the upper layer corresponding to the category reference counter; and
initializing the value of the category reference counter.

14. The processing method of claim 10, wherein
the category reference counter has a hierarchical structure including at least one layer and the layer includes a preset number of category reference counters, and
when a number of category reference counters included in the layer exceeds the preset number, a new layer is additionally formed and category reference counters exceeding the preset number are configured to be included in the new layer.

15. The processing method of claim 10, wherein
a local reference counter is formed for each thread, and
one category counter is configured to support a preset number of threads and to further support local reference counters respectively corresponding to threads having similar characteristics.

16. The processing method of claim 10, wherein
the category reference counter has a hierarchical structure including a plurality of layers, and each layer includes a preset number of category reference counters,
a category reference counter included in a highest layer of the plurality of layers is configured to access the global reference counter, and
the local reference counter is configured to access a category reference counter included in a lowest layer of the plurality of layers,
